(19) United States
(12) Patent Application Publication
(10) Pub. No.: US 2011/0020059 A1
(43) Pub. Date: Jan. 27, 2011

(54) Probe Connector

(76) Inventors: Te-Hung Yin, Taipei (TW); Yung-Yi Chen, Taipei (TW); Shu-Fang Li, Taipei (TW); Jui-Pin Lin, Taipei (TW)

Correspondence Address: Lin & Associates;Intellectual Property, Inc., PO Box 2339, Saratoga, CA, 95070-0339, US

(21) Appl. No.: 12/509,444

(22) Filed: Jul. 25, 2009

(51) Int. Cl. F16D 1/00

(52) U.S. Cl. 403/326

(57) ABSTRACT

A probe connector has a barrel having a main body, with a chamber defined therein, and a base connected with one end of the main body. The main body has a mounting opening at a substantially middle portion thereof and communicating with the chamber. A plunger includes a basic portion restricted in the barrel and a contact portion extended from one end of the basic portion and exposed from the other end of the main body opposite to the base. A resting element has a mounting slice received in the mounting opening, and a resting lump protruding from a side of the mounting slice and protruding into the chamber of the main body to rest against a side of the basic portion when the contact portion is pressed inside the barrel for deflecting the basic portion to contact an inner surface of the main body by an opposite side thereof.

### BACKGROUND OF THE INVENTION

1. Field of the Invention

The present invention relates to a probe connector, and particularly to a probe connector having a structure capable of improving the connection stability between a barrel and a plunger thereof.

2. The Related Art

Please refer to FIG. 4, a conventional probe connector 1′ includes a barrel 10′, an elastic element 30′ received in the barrel 10′, a plunger 20′ mounted to the barrel 10′. The barrel 10′ has a cylindraceous main body 11′ and a base 12′ seated at one end of the main body 11′, with a chamber 13′ defined therein. The chamber 13′ has an inner diameter larger than an outer diameter of the elastic element 30′. The plunger 20′ has a basic portion 21′ movably received in the chamber 13′ of the barrel 10′ and supported by the elastic element 30′, and a contact portion 22′ extended from an end of the basic portion 21′ opposite to the elastic element 30′ and exposes from the other end of the main body 11′ opposite to the base 12′ to contact an outer electrical device. In order to improve the connection stability of the barrel 10′ and the plunger 20′, conventionally, the basic portion 21 ′ is formed with a ramped bottom surface 211 ′ for resting against an end of the elastic element 30′. The ramped bottom surface 211′ of the plunger 20′ makes the elastic element 30′ compress and distort, in turn, the elastic element 30′ is provided with an opposite force which acts on the ramped bottom surface 211 ′ and slants the plunger 20′ to touch the main body 11′. However, such kind of the electrical connection between the barrel 10′ and the plunger 20′ is unstable and apt to break off instantly and discontinuously when the probe connector 1′ suffers from an unexpected force.

### SUMMARY OF THE INVENTION

Accordingly, an object of the present invention is to provide a probe connector having a structure capable of improving the connection stability between a barrel and a plunger thereof. The barrel includes a cylindraceous main body, with a chamber defined therein, and a base connected with one end of the main body. The main body has a mounting opening at a substantially middle portion thereof and communicating with the chamber. The plunger includes a basic portion restricted in the barrel and a contact portion extended from one end of the basic portion and exposed from the other end of the main body opposite to the base. An elastic element is arranged inside the barrel and has two ends respectively abutting against the basic portion and the base. A resting element has a mounting slice received in the mounting opening, and a resting lump protruding from a side surface of the mounting slice and protruding into the chamber of the main body to rest against a side of the basic portion when the contact portion is pressed inside the barrel for deflecting the basic portion to contact an inner surface of the main body by an opposite side thereof.

As described above, the resting lump of the resting element protrudes into the chamber of the probe connector. When the plunger is pressed inside the barrel, the basic portion rests against the resting lump, in turn, the resting lump provides the opposite forces pushing the basic portion to contact the inner surface of the main body securely, preventing the basic portion from breaking off the main body instantly and discontinuously when the probe connector suffers from the unexpected force.

### BRIEF DESCRIPTION OF THE DRAWINGS

The present invention will be apparent to those skilled in the art by reading the following description, with reference to the attached drawings, in which:

FIG. 1 is an exploded, perspective view of a probe connector of an embodiment in accordance with the present invention;

FIG. 2 is a cross-sectional view of the probe connector shown in FIG. 1;

FIG. 3 is a cross-sectional view of the probe connector shown in FIG. 1, wherein a plunger is pressed inside a barrel; and

FIG. 4 is a cross-sectional view of a probe connector in prior art.

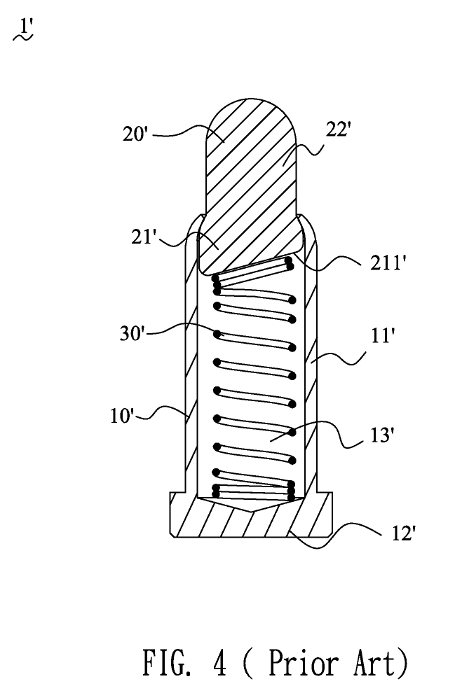

### DETAILED DESCRIPTION OF THE PREFERRED EMBODIMENT

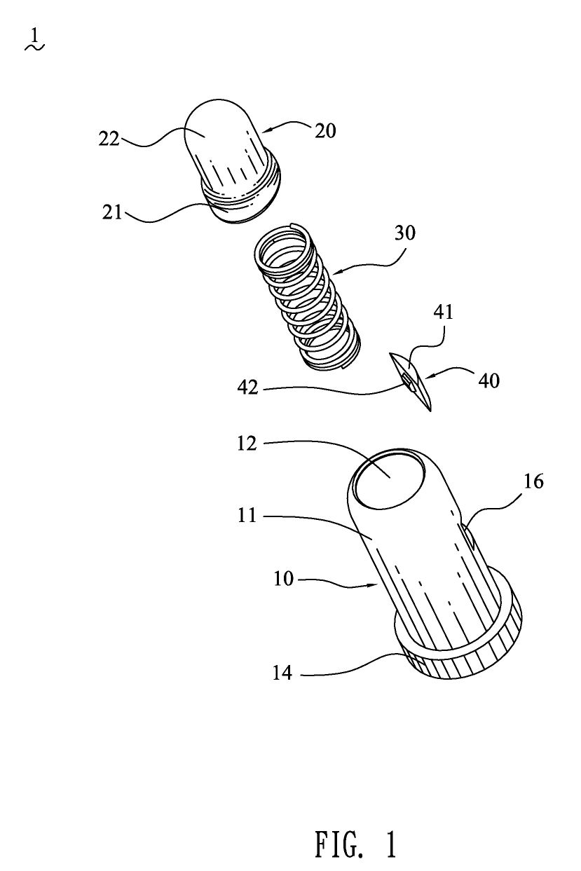

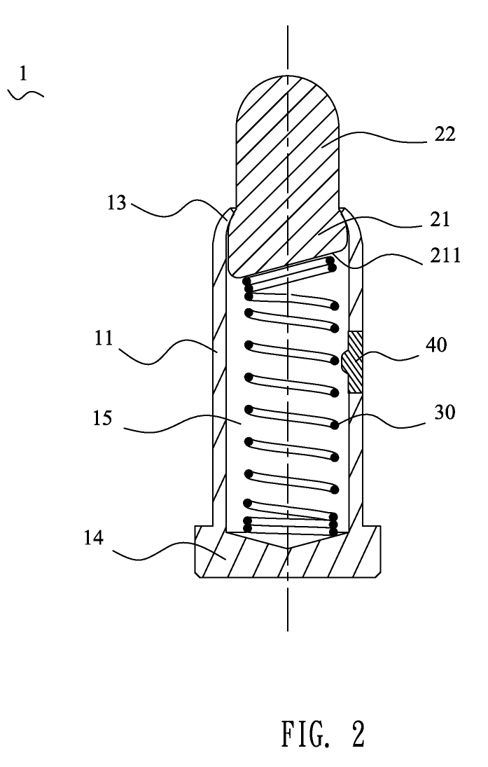

With reference to FIGS. 1-2, the embodiment in accordance with the present invention is embodied in a probe connector 1. The probe connector 1 includes a hollow barrel 10, a plunger 20 and an elastic element 30 received in the barrel 10. The barrel 10 and the plunger 20 are made of metallic material.

The barrel 10 includes a cylindraceous main body 11, with a chamber 15 defined therein, and a base 14 integrated with a bottom end of the main body 11 to show a single piece. The main body 11 has a mounting opening 16 at a substantial middle portion thereof and communicating with the chamber 15. A top end of the main body 11, opposite to the base 14, is open and bent inwards to form a shoulder 13 after the plunger 20 is mounted to the barrel 10. An opening 12 is surrounded by the shoulder 13 for allowing the plunger 20 to pass therethrough.

The plunger 20 of cylindrical shape includes a basic portion 21 and a contact portion 22 extending outwards from one end of the basic portion 21. The basic portion 21 defines a ramped bottom surface 211 opposite to the contact portion 22. The outer diameter of the contact portion 22 is less than that of the basic portion 21, with a free end shaped as a dome. The basic portion 21 is received in the chamber 15 of the barrel 10 and the contact portion 22 extends out of the barrel 10 through the opening 12. The outer dimension of the basic portion 21 is less than the inner dimension of the main body 11 for allowing the basic portion 21 to be inclinably received in the chamber 15. The dimension of the opening 12 is less than the outer dimension of the basic portion 21 for preventing the basic portion 21 from removing out of the chamber 15. The elastic element 30 is arranged inside the main body 11, with two ends abutting against the ramped bottom surface 211 of the basic portion 21 and the base 14, respectively.

The probe connector 1 further has a resting element 40 of plastic material mounted to the main body 11. The resting element 40 has a substantially rectangular mounting slice 41 and a resting lump 42 protruding from a substantially center portion of a side surface of the mounting slice 41. The mounting slice 41 has a surface opposite to the resting lump 42 formed with arc shape. In assembly, the mounting slice 41 is received in the mounting opening 16, with the arc surface conforming to an outer surface of the main body 11 to show a unity. The resting lump 42 projects into the chamber 15 for deflecting the pressed basic portion 21.

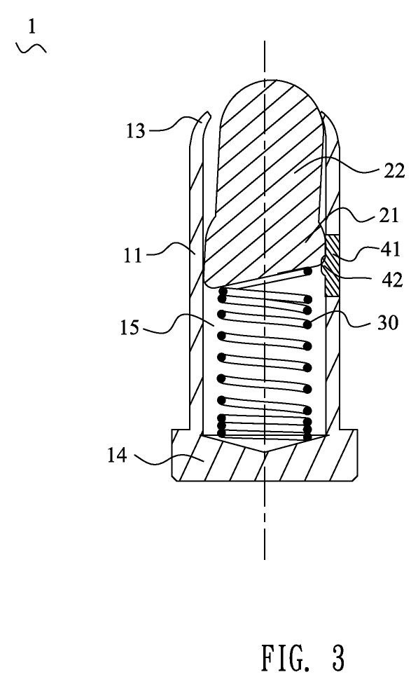

Please refer to the FIG. 3, when the contact portion 22 of the plunger 20 is pressed downwards, the elastic element 30 is compressed downwards and generates an opposite force which acts on the ramped bottom surface 211 of the basic portion 21 so that the basic portion 21 is deflected to contact an inner surface of the main body 11. The resting lump 42 abuts against and extrudes a portion of the basic portion 21 opposite to the connection of the basic portion 21 and the main body 11, thereby guaranteeing the basic portion 21 to contact to the main body 11 securely, without affecting by an unexpected shock or the like.

As described above, the resting lump 42 of the resting element 40 protrudes into the chamber 15 of the probe connector 1. When the plunger 20 is pressed downwards, the basic portion 21 rests against the resting lump 42, in turn, the resting lump 42 provides the opposite forces pushing the basic portion 21 to contact the inner surface of the main body 11 steadily, preventing the basic portion 21 from breaking off the main body 11 instantly and discontinuously when the probe connector 1 suffers from the unexpected force.

The foregoing description of the present invention has been presented for the purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A probe connector, comprising:
a barrel having a cylindraceous main body, with a chamber defined therein, and a base connected with one end of the main body, the main body having a mounting opening at a substantially middle portion thereof and communicating with the chamber;
a plunger including a basic portion restricted in the barrel and a contact portion extended from one end of the basic portion and exposed from the other end of the main body opposite to the base;
an elastic element arranged inside the barrel and having two ends respectively abutting against the basic portion and the base; and
a resting element having a mounting slice received in the mounting opening, and a resting lump protruding from a side surface of the mounting slice and protruding into the chamber of the main body to rest against a side of the basic portion when the contact portion is pressed inside the barrel for deflecting the basic portion to contact an inner surface of the main body by an opposite side thereof.

2. The probe connector as claimed in claim 1, wherein the mounting slice is substantially rectangular.

3. The probe connector as claimed in claim 1, wherein a side of the mounting slice opposite to the resting lump is formed with an arc shape for conforming to an outer side of the main body to show a unity when the mounting slice is mounted in the mounting opening.
